(19) United States
(12) Patent Application Publication
(10) Pub. No.: US 2023/0190044 A1
(43) Pub. Date: Jun. 22, 2023

(54) BLENDER COMPRISING A BALANCED ROTATING TOOL

(71) Applicant: De'Longhi Braun Household GmbH, Neu-Isenburg (DE)

(72) Inventors: Thomas Preiss, Darmstadt (DE); Norbert Kreutz, Wehrheim (DE)

(21) Appl. No.: 17/996,157

(22) PCT Filed: Jan. 26, 2021
(86) PCT No.: PCT/EP2021/051695

§ 371 Date: Oct. 13, 2022

(30) Foreign Application Priority Data
Apr. 28, 2020 (DE) 20 2020 102 359.4

(51) Int. Cl. A47J 43/07; A47J 43/046; A47J 43/08

(52) U.S. Cl. CPC A47J 43/0722; A47J 43/046; A47J 43/085

(57) ABSTRACT

A blender including a container for processing food, a tool disposed inside the container, and rotatably driven by a shaft, and a mass balance element located outside the container for counterbalancing the tool.

### TECHNICAL FIELD

The invention relates to a blender comprising a container for processing food, and a balanced rotating tool.

One type of such tools are knife blades that are used in particular in stationary equipment for chopping food. Tools of this type are generally configured to be rotatably driven at high speeds. Particularly in the case of very fast running work tools, the problem of dynamic imbalance occurs with increasing speeds, thus causing such a work tool to vibrate strongly.

This problem of imbalance occurs not only due to manufacturing tolerances but also due to the arrangement of the knife arms or knife blades, which are usually not arranged such that they extend in one plane, but rather extend in planes offset from one another when viewed in the direction of the drive or rotation axis such that the respective cutting knives run in different planes when chopping the food.

The imbalances and vibrations not only affect the safety of the blenders when they are operated at high speeds, but also put excessive stress on the bearings, which can also lead to excessive heating which is transferred to the food to be chopped. In addition, the uneven running of the cutting knife can cause an undesirably high noise generation.

To ensure an efficient and effective processing operation in a blender, it is also important that the food to be processed can come into contact with the tool in an unimpeded manner, in sufficient quantity and optimally mixed. A correspondingly optimized food material flow within the blender is therefore essential and requires a structural design of the tool such that, as far as possible, only components are installed in the processing space of the blender that are necessarily intended to come into direct contact with the food as part of the processing operation.

### PRIOR ART

In order to compensate for the imbalance of a rotating cutting tool described above, a cutting knife, in particular for chopping food, for attachment to a high-speed drive shaft is known from DE 195 02 216 C1. In order to configure a cutting knife in such a way that running without imbalance is ensured despite mutually offset cutting planes, the knife support arms are each bent towards the plane of the other support arm(s) in a free area adjacent to the axis, and the bent area forms a balancing mass towards the free end of the other support arm(s), wherein the balancing masses of the support arms are dimensioned in such a way that the overall center of gravity of the cutting knife lies in the rotation axis.

Moreover, EP 1 820 431 A1 discloses a tool having a hub mounted on a rotating drive shaft of a food preparation device. A knife is provided with cutting blades, wherein the knife is integrated into the hub such that the blade protrudes radially from the hub and has a balance weight of the tool. The hub has a housing for receiving the weight attached to the hub, wherein the hub has a body and a cover made of a synthetic material.

Other rotating balanced cutting tools for chopping food are known from DE 196 46 329 A1, FR 2 998 466 A1 and JP H04 40919.

Blade shafts in a blender often achieve particularly good chopping performance when the at least two knife blades are placed at different heights on the shaft. This creates different cutting lines, resulting in faster and finer chopping of the food.

A disadvantage of this offset arrangement of, for example, two knife blades is that this blade shaft can no longer easily be completely balanced. A statically balanced rotor can be designed by appropriate mass distribution over the knife blades; however, a considerable dynamic imbalance remains depending on the offset height between the knife blades, thus causing large products of inertia during operation at high speeds.

In addition to high noise generation due to device vibrations, these products of inertia cause a large radial bearing load which can quickly lead to an unallowably high bearing temperature and thus the destruction of the bearing unit. Furthermore, the bearing unit loaded in this way is subject to great wear, which markedly limits its service life.

To compensate for this dynamic imbalance, balancing masses are usually positioned on the blade shaft in the processing area of the blender, which lead to a decrease in performance of the blender and make general handling more difficult.

### DESCRIPTION OF THE INVENTION

The invention is therefore based on the object of providing a blender with a balanced rotating tool, wherein both the performance of the tool is increased and the general handling of the blender is improved.

According to the invention, this object is solved by a device having the features of claim 1. Advantageous embodiments and improvements of the invention can be found in the subclaims.

The invention is based in particular on the finding that a reduced structural configuration of the tool and the tool shaft, which are solely optimized for the processing operation of the food, improves the contact between the food product to be processed and the tool and facilitates the general handling of the blender. By positioning the balance weight for counterbalancing the tool outside the food processing area, it is possible that negative effects caused by the balance weight are avoided in this area of the tool and the tool shaft for the processing operation of the blender.

Using this finding, the invention provides a blender comprising a container for processing food, a tool mounted inside the container and rotatably driven by a shaft, and a mass balance element mounted outside the container for counterbalancing the tool.

The invention thus ensures that the material flow of the food to the tool within the processing container is not disturbed by a mass balance element on the tool itself or on the tool shaft. In this manner, the food can better contact the tool, and the processing performance of the tool is increased. In addition, more space is available inside the container for the food to be processed.

A further advantage is that the mass balance element does not come into direct contact with the food to be processed and therefore does not have to be made of a material suitable for this purpose. For a mass balance element that is arranged outside the container, it is therefore also possible to use materials which, with respect to their weight, are more suitable for use as a mass balance element than the usual food-legislation-compliant materials.

It is a further advantage that the reduced structural design of the tool and the tool shaft without a mass balance element within the container makes it easier to clean and rinse the shaft with the tool after processing food.

Preferably, the blender is configured such that the shaft is supported by a shaft bearing. In this way, it becomes possible, in a fully balanced system, for the shaft bearing to support the weight of the shaft and of the tool. In addition, technically unavoidable imbalance of centrifugal forces can also be absorbed by the shaft bearing, thus preventing them from being transmitted to other components of the blender.

It is further preferred that the shaft comprises, outside the container, a releasable coupling for a drive. This allows the shaft to be decoupled from the drive if required. This has the advantage that the shaft with the tool can be cleaned independently of the drive.

In a further preferred embodiment, the blender is configured such that after the coupling, first the mass balance element, then optionally the shaft bearing, and then the tool are arranged along the rotation axis of the shaft. Due to this arrangement, the tool is positioned at one end of the shaft. This leads to the advantage that only the tool can be positioned in the container and comes into contact with the food to be processed, while the mass balance element is provided outside the container.

Furthermore, it is preferred that the mass balance element is a disk-shaped element and is connected to the shaft in a form-fitting manner. Due to the disk-shaped configuration of the mass balance element, it is possible to position it in an area between the coupling and the shaft bearing. This has the advantage that this area only takes up little space in the blender. Due to the form-fitting configuration, it is also advantageous that the mass balance element is connected to the shaft in the accurate position and in a torsionally rigid manner and rotates with the shaft accordingly.

In a further preferred embodiment, the disk-shaped mass balance element is connected in a form-fitting manner to the shaft via a monoflat body or an asymmetrical biplanar body. Such an embodiment has the advantage of improving the mounting of the disk-shaped balance element on the shaft.

In an even further preferred embodiment, the disk-shaped mass balance element is secured by screwing the coupling onto an external thread of the shaft. It is thus possible to remove the mass balance element from the shaft when needed. In addition, the coupling does not necessarily have to be mounted with positional accuracy since the mass balance element is already connected to the shaft in a form-fitting manner and in the accurate position.

In a further preferred embodiment of the blender, the mass balance element is integrated into the coupling. This has the advantage that there is no need for an additional mass balance element to be mounted, thus facilitating general handling.

Further preferred is a blender in which the tool has two knife blades mounted to the shaft such that they are offset from one another. In this manner, different cutting lines in the food to be processed are possible, resulting in faster and finer crushing of this food.

It is further preferred that the centers of mass of the knife blades and the balance weight lie in a first plane passing through the rotation axis of the shaft, that the unbalanced centrifugal forces of the centers of mass of the knife blades are in momentum equilibrium about an axis that is orthogonal to the first plane and passes through a point of intersection between the rotation axis of the shaft and the force axis related to its centrifugal force of the mass balance weight, and that the unbalanced centrifugal forces of the centers of mass of the knife blades and the mass balance element are in force equilibrium through a second plane passing through the rotation axis of the shaft and orthogonal to the first plane. According to this embodiment, it is ensured that only one balancing plane is provided and that said plane lies in the area of the coupling. It is then possible that only one mass balance element is required in the balancing plane for counterbalancing the tool. The use of a single such element greatly simplifies the design of the blender. The centrifugal forces scale with the square of the angular velocity of the rotation. However, since all centers of mass rotate about the same axis, they all have the same angular velocity, which is why it is possible to determine the equilibria of the centrifugal forces and the corresponding moments for the blender per se without it having to be in operation.

### BRIEF DESCRIPTION OF THE DRAWINGS

Further features and advantages of the devices are apparent from the following description of embodiments with reference to the enclosed drawings. In these drawings,

FIG. 1 shows a view of the blender with the container screwed off;

FIG. 2 shows a view of the knife blades and of the shaft of the blender;

FIG. 3 shows an exploded illustration of the form-fitting connection between the shaft and the disk-shaped mass balance element;

FIG. 4 shows a schematic view of the geometric relationships of the blender; and

FIG. 5 shows a schematic view of the geometric relationships of the blender.

### DESCRIPTION OF EMBODIMENTS

It is clear to the skilled person that individual features described in different embodiments can also be implemented in a single embodiment, provided they are not structurally incompatible. Likewise, various features described in the context of a single embodiment may also be provided in several embodiments either individually or in any suitable sub-combination.

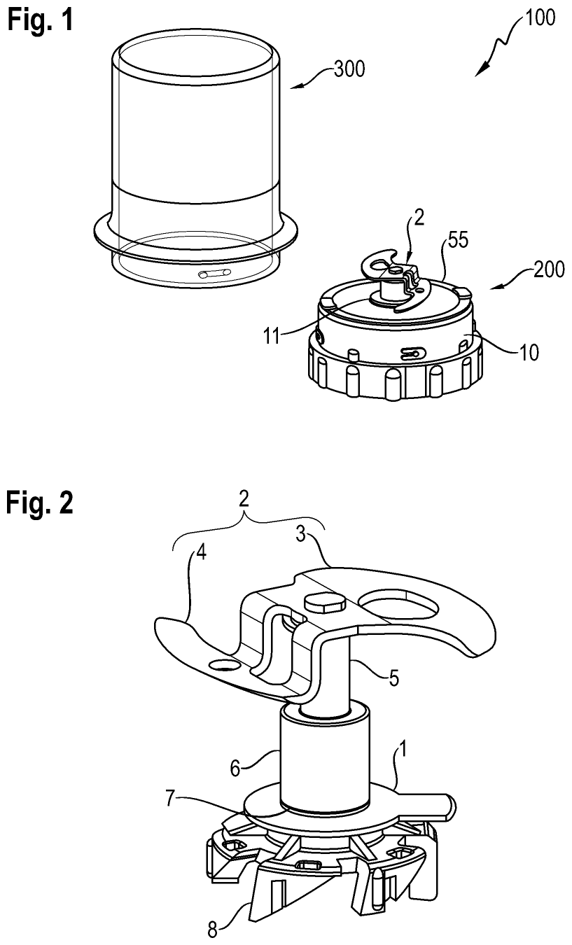

FIG. 1 shows a possible embodiment of the blender 100 having a base 200 and a cylindrical container 300 decoupled therefrom for processing food products. The container 300, which is not restricted to a cylindrical shape, and the base 200 may be coupled together using, for example, a screw and/or plug connection. A bayonet connection is also possible. Thus, the container 300 can be decoupled from the base 200 for filling the blender 100, a closed processing space can be provided during the processing operation by coupling, and the base can be decoupled again for emptying the container 300. Preferably, the processing space is sealed from the environment at the contact surface between the container 200 and the base 300 by means of a sealing ring 55.

The base 200 of the blender has a rotating tool 2 for processing food which is arranged such that it is located inside the container 300 when said container is coupled to the base 200. In other words, the tool 2 rotates in an inner area of the container 300 during the food processing operation. Or, to put in another way, the surfaces limiting the container 300 enclose the tool 2 and the food during processing.

FIG. 2 shows an enlarged view of the tool 2 from FIG. 1. Preferably, this tool is mounted to the end of a rotatable shaft 5, in particular in a detachable manner. According to the present embodiment, the tool 2 is equipped, for example, with two knife blades 3, 4 running in planes that are offset from one another along the rotation axis of the shaft 5 such that the respective knife blades 3, 4 run in different planes when chopping the food. The number of knife blades and their shape can vary depending on the food to be processed and be adapted to the processing operation. Moreover, the tool 2 can also be configured, for example, to additionally ensure optimal mixing of the food to be processed during the chopping process.

The shaft 5 is preferably supported by a shaft bearing 6, which is located along the rotation axis of the shaft 5 below the tool 2, and encloses the shaft 5. The part of the shaft 5, which is located between the shaft bearing 6 and the tool 2, is also disposed inside the container 300 during the processing operation. As shown in FIG. 1, it is also possible for at least a part of the shaft bearing 6 to be located inside the container 200, while the other part of the shaft bearing 6 is located within the housing 10 of the base 200. The housing 10 of the base 200 has an opening 11 on the side facing the container 300, which surrounds the shaft bearing 6 in a form-fitting manner such that the processed food cannot enter the interior of the housing 10 of the base 200 during the processing operation.

Arranged along the rotation axis, in particular below the shaft bearing 6, is first a disk-shaped slide ring 7 and then a mass balance element 1 which in this embodiment is configured to be disk-shaped. Still further down along the rotation axis, a coupling 8 is located which can be coupled to a drive that is not shown. Thus, as already mentioned in the upper section, in addition to the at least one part of the shaft bearing 6, the slide ring 7, the disk-shaped balance element 1 and the coupling 8 are also located inside the housing 10 of the base 200 and are thus not in contact with the food to be processed inside the processing space.

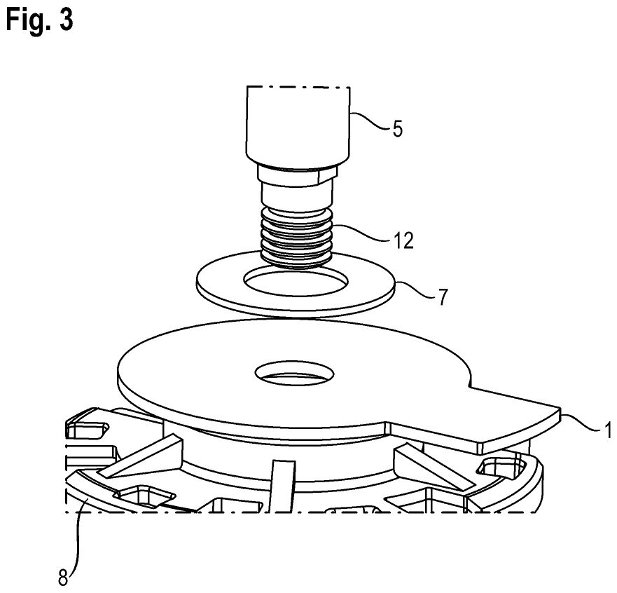

FIG. 3 shows an exploded view of the form-fitting connection between the shaft 5 and the disk-shaped mass balance element 1. The end of the shaft 5 is in particular provided with an external thread 12 which can be screwed into a matching internal thread of the coupling 8. Formed in the disk-shaped mass balance element 1 is an opening which, for example, is in the form of a monoflat body or an asymmetrical biplanar body. Along the rotation axis of the shaft 5, above the external thread 12, a section of the shaft is formed in such a way that it can be connected as a counterpart in a form-fitting manner to the opening of the disk-shaped mass balance element 1, which is formed as a monoflat body or asymmetrical biplanar body, by sliding the disk-shaped mass balance element onto the shaft 5.

In the assembled state, the disk-shaped mass balance element 1 is connected to the shaft 5 in a form-fitting manner and secured to the shaft 5 by the coupling being screwed on. It thus becomes possible that the disk-shaped mass balance element 1 rotates together with the coupling in a form-fitting manner. The disk-shaped slide ring 7 is, in particular, positioned along the rotation axis of the shaft 5 between the shaft bearing 6 and the disk-shaped mass balance element 1 such that there is no contact surface between the shaft bearing 6 and the disk-shaped mass balance element 1.

In particular an element with a defined mass is located at the outer area of the disk-shaped mass balance element 1 in such a way that the otherwise circular shape of the mass balance element is interrupted at this position. In the present embodiment, this is preferably a rectangular bar formed at the outer radial end of a circle 1.

In an embodiment not shown, this can also be realized, for example, by accumulating material at a point on the surface of the mass balance element 1. The mass of the corresponding element corresponds to the balancing mass for counterbalancing the tool 2. If different tools 2 to be counterbalanced can be mounted in a blender, it is in particular possible to correspondingly exchange the disk-shaped mass balance elements 1.

In an embodiment not shown, a mass balance element is integrated into the coupling 8 instead of the disk-shaped mass balance element. This mass balance element can be formed, for example, by an accumulation of material on one side of a plastic coupling, or can be introduced in the form of a balance weight into an accordingly provided pocket/receptacle of the coupling 8. Further preferably, different balance weights can be inserted into the pocket/receptacle to match the corresponding tool 2.

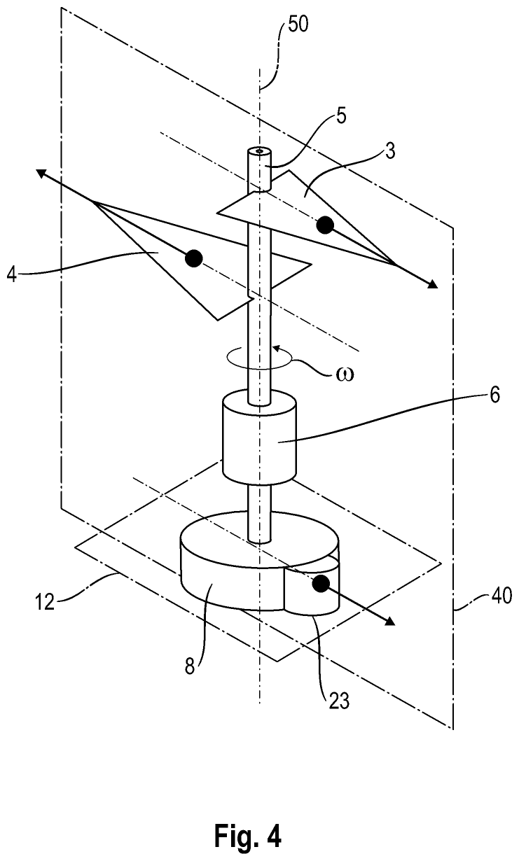

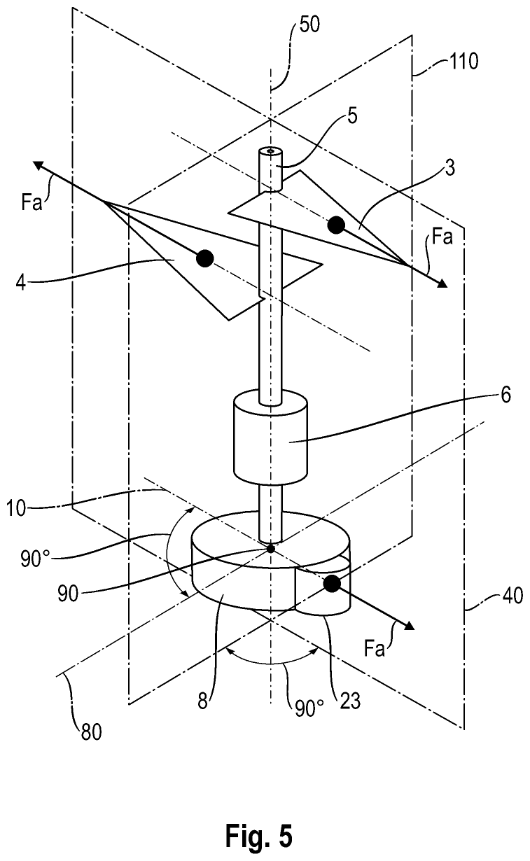

FIGS. 4 and 5 schematically show the geometrical arrangement of the shaft 5, the tool 2 with the knife blades 3, 4, the coupling 6 and the mass balance element 23 in such a way that the blender is completely counterbalanced. Since the mass balance element 23 should be positioned outside the processing area of the blender, only one balancing plane is used which lies in the coupling plane 12 of the blade shaft 5. To be able to use only this one balancing plane for mass balancing to achieve full counterbalancing, the entire blade shaft must be designed with regard to the mass distribution in such a way that the technical special case of counterbalancing occurs, i.e. that already one mass balance element 23 is sufficient to fully counterbalance the rotor with the tool 2.

For this purpose, the individual centers of gravity of the knife blades 3, 4 and the mass balance weight lie in a plane 40 through the rotation axis 50. The unbalanced centrifugal forces of the individual centers of gravity of the knife blades 3, 4 are also in momentum equilibrium about the axis 80, which is orthogonal to the plane 4 in which all centers of gravity lie, and passes through the intersection point 90 between the rotation axis 50 and force axis 10 of the mass balance weight 23.

The unbalanced centrifugal forces of the individual centers of gravity of the knife blades 3, 4 as well as those of the balance weight 23 are in force equilibrium through the plane 110 which runs through the rotation axis 55 and perpendicular to the plane 4 in which all centers of gravity lie. For a given center of gravity radius, this results in the mass of the mass balance element 23 or, for a given mass of the mass balance element 23, the center of gravity radius.

All calculations assume that the radial bearing forces of the shaft bearing are set to zero such that in a fully counterbalanced system only the weight force of the blade shaft needs to be axially supported.

Although the claims in the present case are directed at a blender, the invention can also be used for spice mills, in stirring devices (e.g. food processors), or in jugs in which food is chopped.

1. A blender comprising:
a container for processing food,
a tool located inside the container and rotatably driven by a shaft, and
a mass balance element for counterbalancing the tool located outside the container.

2. The blender according to claim 1, wherein the shaft is supported by a shaft bearing.

3. The blender according to claim 1, wherein the shaft comprises a coupling for a drive located outside the container.

4. The blender according to claim 2, wherein after a coupling, first the mass balance element, then the shaft bearing and then the tool are arranged along a rotation axis of the shaft.

5. The blender according to claim 1, wherein the mass balance element comprises a disk-shaped element connected to the shaft in a form-fitting manner.

6. The blender according to claim 5, wherein the mass balance element is connected to the shaft by a monoflat body or an asymmetrical biplanar body.

7. The blender according to claim 3, wherein the mass balance element is secured to the shaft by screwing the coupling onto an external thread of the shaft.

8. The blender according to claim 3, wherein the mass balance element is integrated into the coupling.

9. The blender according to claim 1, wherein the tool comprises two knife blades that are mounted offset from each other to the shaft.

10. The blender according to claim 9, wherein
centers of mass of the knife blades and of a balance weight lie in a first plane extending through a rotation axis of the shaft, and
wherein unbalanced centrifugal forces of the centers of mass of the knife blades are in momentum equilibrium about an axis that is orthogonal to the first plane and passes through an intersection point between the rotation axis of the shaft and a force axis of the mass balance weight, and
wherein the unbalanced centrifugal forces of the centers of mass of the knife blades and of the mass balance element are in force equilibrium through a second plane that passes through the rotation axis of the shaft and is orthogonal to the first plane.
